(19) United States
(12) Patent Application Publication
(10) Pub. No.: US 2007/0216251 A1
(43) Pub. Date: Sep. 20, 2007

(54) MOTOR

(75) Inventors: Jang-Ho SHIM, Seoul (KR); Seong-Ho LEE, Gyeonggi-Do (KR); Jae-Min KIM, Seoul (KR); Jae-Hak CHOI, Seoul (KR); Jin-Soo PARK, Incheon (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/627,559

(22) Filed: Jan. 26, 2007

(30) Foreign Application Priority Data
Mar. 17, 2006 (KR) 10-2006-0024999

(51) Int. Cl. H02K 21/12; H02P 1/46

(52) U.S. Cl. 310/156.53; 310/DIG. 2; 310/156.03; 318/701

(57) ABSTRACT

A motor includes a stator which generates a rotating magnetic field, and a rotor. The rotor includes a plurality of permanent magnets and a hysteresis band disposed on an outer periphery of the rotor.

### RELATED APPLICATION

The present disclosure relates to subject matter contained in Korean Patent Application No. 10-2006-0024999, filed on Mar. 17, 2006, which is herein expressly incorporated by reference in its entirety.

### BACKGROUND OF THE INVENTION

1. Field of the Invention

The present invention relates to a motor, and more specifically, to a motor which has a high torque when initially starting.

2. Description of the Conventional Art

FIG. 1 is a schematic view of a conventional motor, and FIG. 2 is a graph illustrating the relationship between the torque and the speed of the conventional motor.

The conventional motor shown in FIG. 1 includes a stator 10 having a plurality of teeth 11, and a rotor 20. The teeth 11 define a plurality of slots 12 therebetween, and a through hole 13 formed at the center of the stator 10. A coil (not shown) is wound around the teeth 11, and generates a rotating magnetic field when an electric current is applied thereto. The rotor 20 includes an axle hole 22 in which a rotating axle (not shown) is inserted, four permanent magnets 23 that are disposed in a rhombus shape around the axle hole 22, and a plurality of cage bars 21 that are disposed at constant intervals along the edge of the rotor 20. The rotor 20 is disposed in the through hole 13 of the stator 10.

The cage bars 21 generate a cage torque, and the permanent magnets 23 generate a magnet torque. The sum of the cage torque and the magnet torque is referred to here as a ‘resultant torque’ of the motor.

When the conventional motor is initially started, the cage bars 21 generate a cage torque in one direction, and the permanent magnets generate a magnet torque in an opposite direction (referred to as a ‘braking torque’). As shown in FIG. 2, the cage torque is greater than the magnet torque.

When the conventional motor is initially started, the rotor 20 begins accelerating. When the rotor 20 reaches a synchronous speed, at which the speed of the rotor 20 equals the speed of the rotating magnetic field generated by the teeth 11 (shown as ‘1’ in FIG. 2), a voltage is no longer induced in the cage bars 21, and thus, the cage bars 21 cease to generate a cage torque. Thus, when the rotor 20 is rotating at the synchronous speed, the rotor 20 is rotated only by the magnet torque generated by the permanent magnets 23.

### SUMMARY OF THE INVENTION

One of the features of the present invention is a motor which has a high torque when initially starting.

To achieve at least this feature, there is provided a motor which includes a stator which generates a rotating magnetic field, and a rotor which includes a plurality of permanent magnets and a hysteresis band disposed on an outer periphery of the rotor.

The hysteresis band may be a ring-shaped magnetic body. The hysteresis band may be a neodymium NdFeB bond magnet. The hysteresis band may generate a hysteresis torque which offsets a magnet torque generated by the plurality of permanent magnets.

The stator may include a plurality of teeth defining a plurality of slots therebetween. The plurality of teeth may define a through hole formed in a center of the stator. The rotor may be disposed within the through hole. The stator may include a coil, wound around the plurality of teeth, which generates the rotating magnetic field when an electric current is applied thereto.

The rotor may include an axle hole into which a rotating axle is inserted. The plurality of permanent magnets may be disposed around the axle hole. An eddy current in the hysteresis band may generate an eddy torque.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of a conventional motor;

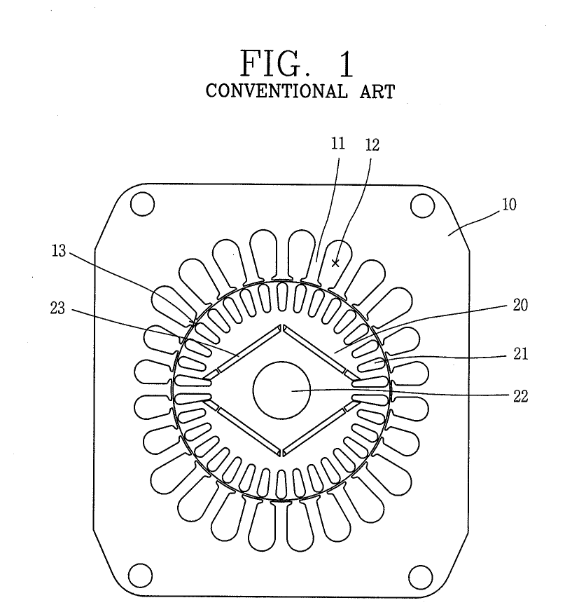

FIG. 2 is a graph illustrating a relationship between the torque and the speed of the conventional motor;

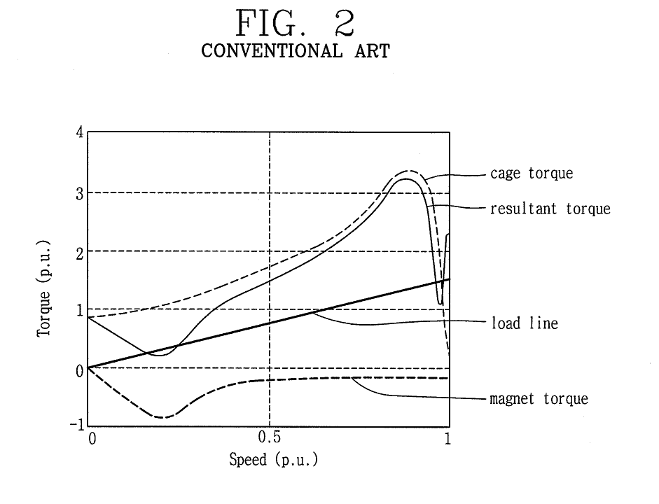

FIG. 3 is a schematic view of an embodiment of a motor according to the present invention; and

FIG. 4 is a graph illustrating a relationship between the torque and the speed of the motor of FIG. 3.

### DETAILED DESCRIPTION OF THE PREFERRED EMBODIMENT

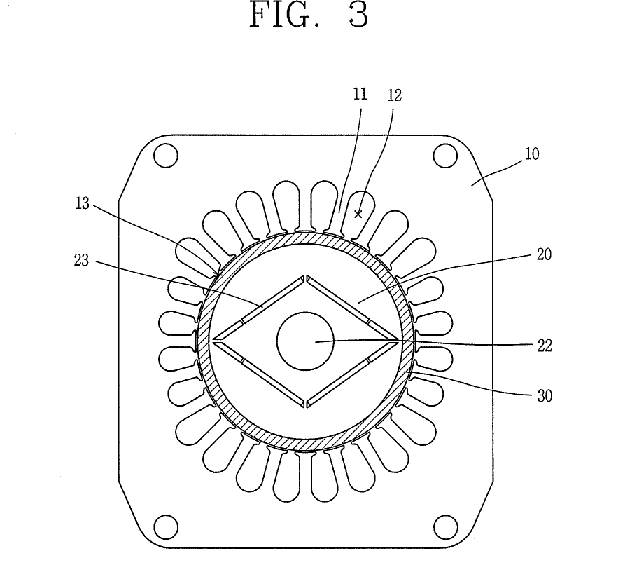

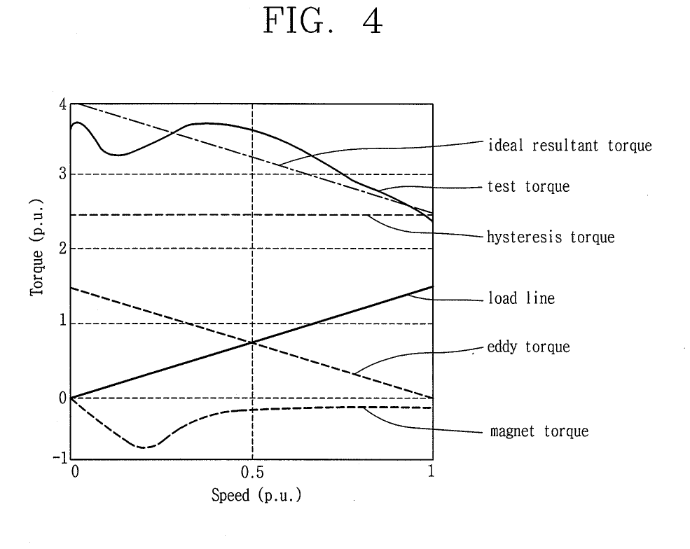

FIG. 3 is a schematic view of an embodiment of a motor according to the present invention. FIG. 4 is a graph illustrating a relationship between the torque and the speed of the motor shown in FIG. 3.

The motor shown in FIG. 3 includes a stator 10 having a plurality of teeth 11, and a rotor 20. The teeth 11 define a plurality of slots 12 therebetween, and a through hole 13 formed at the center of the stator 10. A coil (not shown) is wound around the teeth 11, and generates a rotating magnetic field when an electric current is applied thereto. The rotor 20 includes an axle hole 22 into which a rotating axle is inserted (not shown), a plurality of permanent magnets 23 disposed around the axle hole 22, and a hysteresis band 30 that is disposed on an outer periphery of the rotor 20.

The permanent magnets 23 may be disposed, for example, in a rhombus shape at predetermined intervals around the axle hole 22.

The hysteresis band 30 is a ring-shaped magnetic body disposed on the outer periphery of the rotor 20. The hysteresis band is preferably a magnet having a high coercive force and low magnetic flux density, such as, for example, a neodymium NdFeB bond magnet.

The hysteresis band 30 can be separately built and attached to the rotor 20, or it can be integrated with the rotor 20, for example, by injection molding.

When the motor is initially started, the hysteresis band 30 generates a hysteresis torque, an eddy current within the hysteresis band 30 generates an eddy torque, and the permanent magnets 23 generate a magnet torque, as shown in FIG. 4. As shown in FIG. 4, the magnet torque is a negative torque, i.e., has an opposite direction to the hysteresis torque and the eddy torque. The sum of the hysteresis torque, the eddy torque and the magnet torque is referred to here as an ‘ideal resultant torque’. However, due to the influence of a load line attached to the motor, an actual resultant torque follows a curve pattern similar to the ‘test torque’ pattern shown in FIG. 4.

When the motor is started, the rotor 20 accelerates, and the eddy torque decreases, as shown in FIG. 4. When the speed of the rotor 20 reaches a synchronous speed (shown as ‘I’ in FIG. 4), at which the speed of the rotor 20 is equal to the speed of the rotating magnetic field generated by the teeth 11, the eddy torque ceases to exist (i.e., decreases to substantially 0), but the hysteresis torque and magnet torque remain.

As shown in FIG. 4, an advantageous feature of the motor shown in FIG. 3 is that it has a high torque when the motor is initially started, due to the combination of the hysteresis torque and the eddy torque generated by the hysteresis band 30, which overcome a braking torque of the permanent magnets 23.

Although the preferred embodiment of the present invention has been described, the present invention is not limited to the disclosed embodiment, but may be modified in many different forms within the scope defined by the appended claims.

What is claimed is:

1. A motor, comprising:
a stator which generates a rotating magnetic field; and
a rotor, comprising a plurality of permanent magnets and a hysteresis band disposed on an outer periphery of the rotor.

2. The motor of claim 1, wherein the hysteresis band comprises a ring-shaped magnetic body.

3. The motor of claim 1, wherein the hysteresis band comprise a neodymium NdFeB bond magnet.

4. The motor of claim 1, wherein the hysteresis band generates a hysteresis torque which offsets a magnet torque generated by the plurality of permanent magnets.

5. The motor of claim 1, wherein the stator comprises a plurality of teeth defining a plurality of slots therebetween.

6. The motor of claim 5, wherein the plurality of teeth define a through hole formed in a center of the stator.

7. The motor of claim 6, wherein the rotor is disposed within the through hole.

8. The motor of claim 5, wherein the stator comprises a coil, wound around the plurality of teeth, which generates the rotating magnetic field when an electric current is applied thereto.

9. The motor of claim 1, wherein the rotor comprises an axle hole into which a rotating axle is inserted.

10. The motor of claim 9, wherein the plurality of permanent magnets are disposed around the axle hole.

11. The motor of claim 1, wherein an eddy current in the hysteresis band generates an eddy torque.

12. A motor, comprising:
a stator, comprising a plurality of teeth defining a plurality of slots therebetween and a through hole formed in a center of the stator, and a coil wound around the teeth which generates a rotating magnetic field when an electric current is applied thereto; and
a rotor disposed in the through hole, comprising an axle hole into which a rotating axle is inserted, a plurality of permanent magnets disposed around the axle hole, and a hysteresis band that is disposed on an outer periphery of the rotator, the hysteresis comprising a ring-shaped neodymium NdFeB bond magnet.

13. The motor of claim 12, wherein the hysteresis band generates a hysteresis torque which offsets a magnet torque generated by the plurality of permanent magnets.

14. The motor of claim 12, wherein an eddy current in the hysteresis band generates an eddy torque.
